(19) United States
(12) Patent Application Publication
(10) Pub. No.: US 2026/0107307 A1
(43) Pub. Date: Apr. 16, 2026

(54) EARLY DATA TRANSMISSION IN ENHANCED COVERAGE USING DIVERSITY SLOTTED ALOHA IN NON-TERRESTRIAL NETWORKS

(71) Applicant: InterDigital Patent Holdings, Inc., Wilmington, DE (US)

(72) Inventors: Brian Martin, Farnham (GB); Umer Salim, Vallauris (FR); Moon IL Lee, Melville, NY (US); Dylan Watts, Montreal (CA); Ghyslain Pelletier, Montreal (CA)

(73) Assignee: InterDigital Patent Holdings, Inc., Wilmington, DE (US)

(21) Appl. No.: 19/093,923

(22) Filed: Mar. 28, 2025

Related U.S. Application Data
(60) Provisional application No. 63/707,011, filed on Oct. 14, 2024.

(51) Int. Cl. H04W 74/0816; H04W 48/10; H04W 74/0833; H04W 84/06

(52) U.S. Cl. CPC H04W 74/0816; H04W 48/10; H04W 74/085; H04W 84/06

(57) ABSTRACT

Systems, methods, and instrumentalities are described herein that may be associated with early data transmission in enhanced coverage using diversity slotted aloha in non-terrestrial networks. A device may be configured to receive broadcast configuration information. The broadcast configuration information may include a first condition and a second condition. A first coverage level may be determined based on whether the first condition is satisfied. A random-access configuration associated with the first coverage level may be selected based on the broadcast configuration information and based on whether the second condition is satisfied. Based on a determination that the random-access configuration enables a preamble-less early data transmission (EDT), the WTRU may determine at least at one physical uplink shared channel (PUSCH) resource allocation parameter. The random-access configuration and the PUSCH at least one resource allocation parameter may be transmitted using the preamble-less EDT.

### CROSS-REFERENCE TO RELATED APPLICATIONS

This application claims the benefit of Provisional U.S. Patent Application No. 63/707,011, filed Oct. 14, 2024, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein that may be associated with early data transmission in enhanced coverage using diversity slotted aloha in non-terrestrial networks.

A device (e.g., a wireless transmit/receive unit (WTRU)) may be configured to receive broadcast configuration information. The broadcast configuration information may include a first condition and a second condition. A first coverage level may be determined based on whether the first condition is satisfied (e.g., based on the first condition being satisfied). A random-access configuration associated with the first coverage level may be selected based on the broadcast configuration information and based on whether the second condition is satisfied (e.g., based on the broadcast configuration information and based on the second condition being satisfied). In examples, the second condition may be at least one of: a type of transmission condition, a location or time-based condition, a threshold for enabling diversity slotted ALOHA (DSA) for the coverage level, a condition based on an explicit response from a network, or a condition based on WTRU-ID based parameters.

Based on a determination that the random-access configuration enables a preamble-less early data transmission (EDT), the WTRU may determine at least at one physical uplink shared channel (PUSCH) resource allocation parameter. The at least one PUSCH resource allocation parameter may include one or more of: a number of duplicate packets, a number of repetitions for each duplicate packet, a time between each duplicate packet, a narrowband to transmit for each duplicate packet, or a resource block (RB) for each duplicate packet.

The random-access configuration and the at least one PUSCH transmission parameter may be transmitted using the preamble-less EDT (e.g., the transmission may use at least one of the preamble-less EDT, the random-access configuration, or the at least one PUSCH resource allocation parameter). Based on a determination that the transmission is not successful, a second coverage level may be selected.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of different radio interfaces in a non-terrestrial network (NTN).

FIG. 3 illustrates an example of a radio resource control (RRC) connection established for control plane CIoT EPS/5GS optimizations.

FIG. 4 illustrates an example of an RRC connection suspend procedure in an evolved packet system (EPS).

FIG. 5 illustrates an example of an RRC connection resume procedure in EPS.

FIG. 6 illustrates an example of a mobile-originated early data transmission (MO-EDT) for control plane cellular internet of things (CIoT) evolved packet system (EPS) optimization.

FIG. 7 illustrates an example of a mobile terminated early data transmission (MT-EDT) procedure for control plane CIoT EPS optimization.

FIG. 8 illustrates an example of a preconfigured uplink resource (PUR) configuration request and a PUR configuration.

FIG. 9 illustrates an example of a transmission using PUR for the control plane CIoT EPS/5GS optimizations.

FIG. 10 illustrates an example of packet duplication using contention resolution diversity slotted ALOHA (CRDSA).

FIG. 11 illustrates an example of an early data transmission (EDT) in enhanced coverage using diversity slotted ALOHA (DSA).

### DETAILED DESCRIPTION

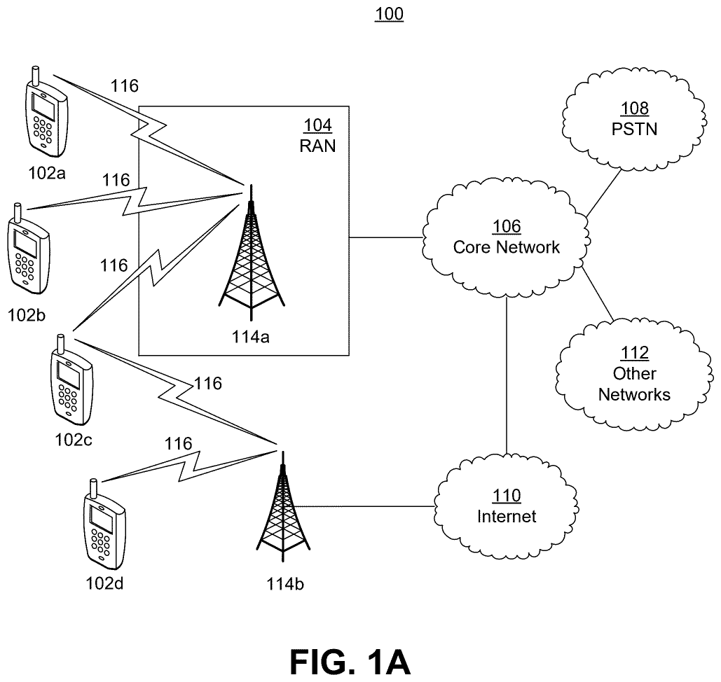

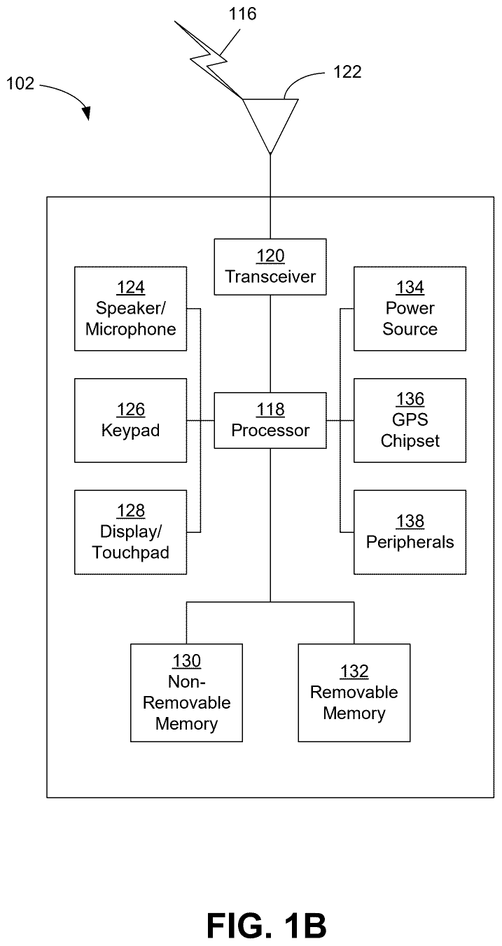

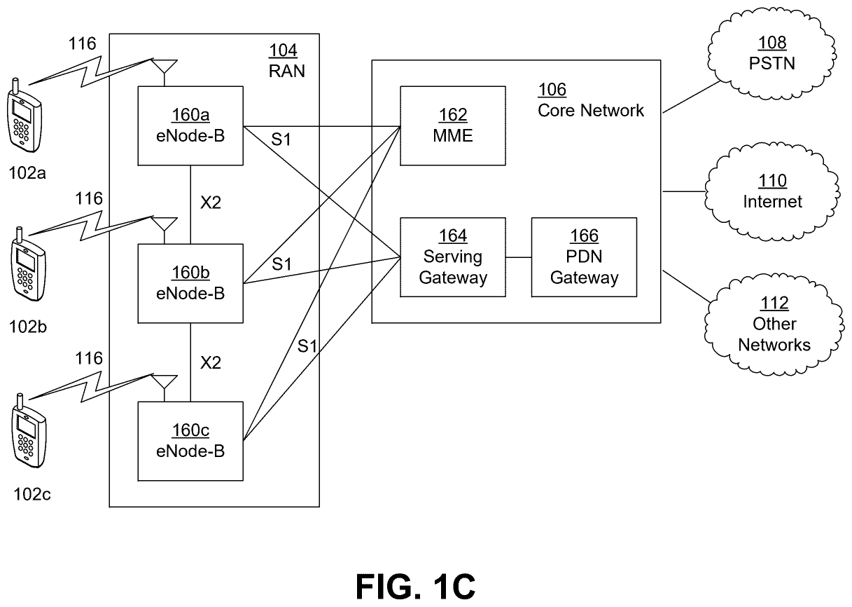

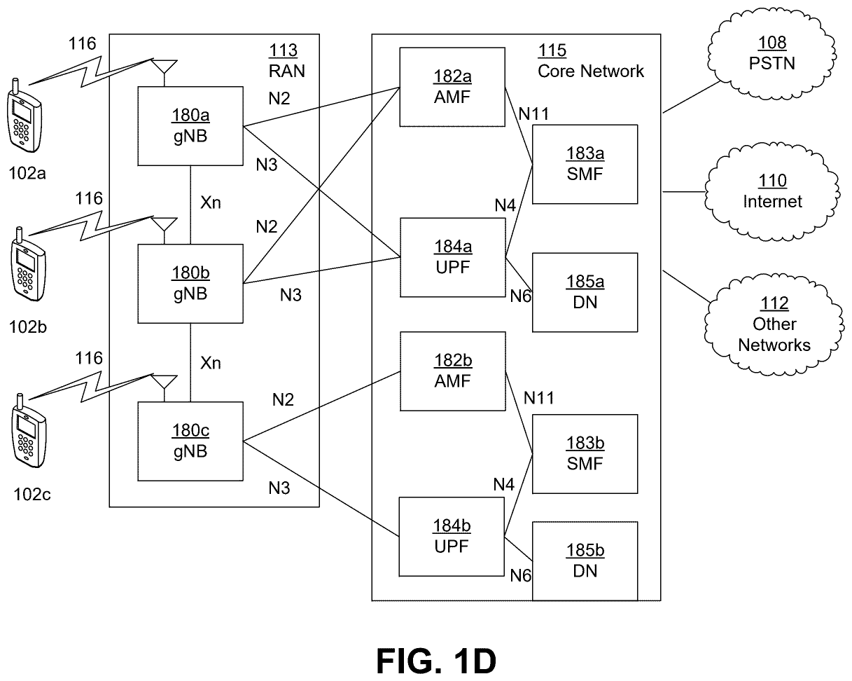

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc.

Systems, methods, and instrumentalities are described herein that may be associated with early data transmission in enhanced coverage using diversity slotted aloha in non-terrestrial networks.

A device (e.g., a wireless transmit/receive unit (WTRU)) may be configured to receive broadcast configuration information. The broadcast configuration information may include a first condition and a second condition. A first coverage level may be determined based on whether the first condition is satisfied (e.g., based on the first condition being satisfied). A random-access configuration associated with the first coverage level may be selected based on the broadcast configuration information and based on whether the second condition is satisfied (e.g., based on the broadcast configuration information and based on the second condition being satisfied). In examples, the second condition may be at least one of: a type of transmission condition, a location or time-based condition, a threshold for enabling diversity slotted ALOHA (DSA) for the coverage level, a condition based on an explicit response from a network, or a condition based on WTRU-ID based parameters.

Based on a determination that the random-access configuration enables a preamble-less early data transmission (EDT), the WTRU may determine at least at one physical uplink shared channel (PUSCH) resource allocation parameter. The at least one PUSCH resource allocation parameter may include one or more of: a number of duplicate packets, a number of repetitions for each duplicate packet, a time between each duplicate packet, a narrowband to transmit for each duplicate packet, or a resource block (RB) for each duplicate packet.

The random-access configuration and the at least one PUSCH transmission parameter may be transmitted using the preamble-less EDT (e.g., the transmission may use at least one of the preamble-less EDT, the random-access configuration, or the at least one PUSCH resource allocation parameter). Based on a determination that the transmission is not successful, a second coverage level may be selected.

Examples of DSA parameters based on coverage level determination (e.g., number of duplicates, time offset, carrier, repetitions) are provided herein. Examples of falling back to RACH based EDT are provided herein. Examples of dedicated configurations of high priority resources are provided herein.

Examples of non-terrestrial networks (NTN) are provided herein. An NTN may include an aerial or space-borne platform which (e.g., via a gateway (GW)) may transport signals from a land-based based gNB to a WTRU and vice-versa. Support for LTE-based narrow-band IoT (NB-IoT) and eMTC type devices are provided herein. Regardless of device type, NTN WTRUs may be GNSS capable.

Aerial or space-borne platforms may be classified in terms of orbit. Low-earth orbit (LEO) satellites may have an altitude range of 300-1500 km and geostationary earth orbit (GEO) satellites may have an altitude at 35 786 km. Other platform classifications such as medium-earth orbit (MEO) satellites may have an altitude range of 7000-25000 km and high-altitude platform stations (HAPS) may have an altitude range of 8-50 km. Satellite platforms may be classified as having a transparent or regenerative payload. Transparent satellite payloads may implement frequency conversion and RF amplification in both uplink and downlink. Multiple transparent satellites may be connected to one land-based gNB. Regenerative satellite payloads may implement either a full gNB or gNB DU onboard the satellite. Regenerative payloads may perform digital processing on the signal including at least one of demodulation, decoding, re-encoding, re-modulation, or filtering.

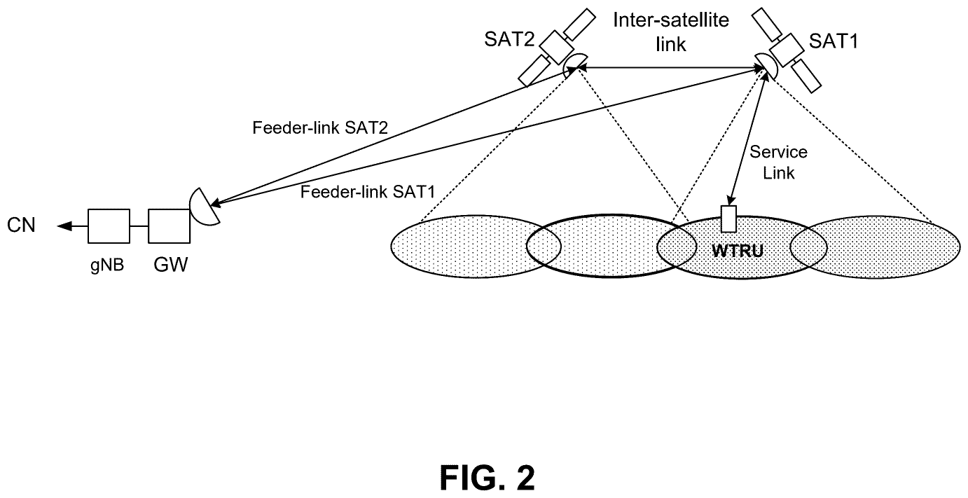

FIG. 2 illustrates an example of different radio interfaces in an NTN. A feeder-link may be a wireless link between the GW and satellite. A service link may be a radio link between the satellite and WTRU. An inter-satellite link (ISL) may be a transport link between satellites. The ISL may be supported by regenerative payloads and may be a radio or proprietary optical interface.

An NTN satellite may support multiple cells. The cells (e.g., each cell) may include one or more satellite beams. The satellite beams may cover a footprint on earth (e.g., a terrestrial cell) and may range in diameter from 100-1000 km in LEO deployments and 200-3500 km diameter in GEO deployments. Beam footprints in GEO deployments may remain fixed relative to earth. In LEO deployments, the area covered by a beam/cell may change over time due to satellite movement. This beam movement may be classified as earth moving or earth fixed. In earth moving, the LEO beam may move continuously across the earth. In earth fixed, the beam may be steered to remain covering a fixed location until a new cell overtakes the coverage area in a discrete and coordinated change.

Due to the altitude of NTN platforms and beam diameter, the round-trip time (RTT) and maximum differential delay may be significantly larger than that of terrestrial systems. In a transparent NTN deployment, RTT may range from 25.77 ms (LEO @ 600 km altitude) to 541.46 ms (GEO). Maximum differential delay may range from 3.12 ms to 10.3 ms. The RTT of a regenerative payload may be approximately half that of a transparent payload. A transparent configuration may include both the service and feeder links, whereas the RTT of a regenerative payload may consider the service link (e.g., only the service link). To minimize the impact to existing systems (e.g., to avoid preamble ambiguity or properly time reception windows), prior to initial access, a WTRU may perform timing pre-compensation.

The WTRU may obtain its position via GNSS in a timing pre-compensation procedure. The WTRU may obtain its feeder-link (or common) delay and satellite position via satellite ephemeris data in a pre-compensation procedure. The satellite ephemeris data may be periodically broadcasted in system information. The satellite ephemeris data may include at least one of the satellite speed, direction, or velocity. The WTRU may (e.g., may then) estimate the distance (and thus delay) from the satellite. The WTRU may (e.g., may then) add the feeder-link delay component to obtain the full WTRU-eNB RTT, which may (e.g., may then) be used to offset timers, reception windows, or timing relations. Frequency compensation may be performed by the network.

Example enhancements in NTN may concern WTRU mobility and measurement reporting. The difference in RSRP between cell center and cell edge may be not as pronounced as in terrestrial systems. This, coupled with the much larger region of cell overlap results in traditional measurement-based mobility, may become less reliable in an NTN environment. Conditional handover and measurement reporting triggers relying on location and time may be provided (e.g., for both NR and IoT-NTN). Enhanced mobility may be included in LEO deployments where, due to satellite movement, even a stationary WTRU may be expected to perform mobility approximately every seven seconds (e.g., depending on deployment characteristics).

Examples of CIoT signaling reduction optimizations are provided herein. In control plane examples, data may be sent in an NAS message transmitted in an RRC container message (e.g., sent in a control plane RRC message). In user plane examples, the WTRU may be configured to store its AS context if being sent to RRC_IDLE using a suspend message. The WTRU may restore the AS context when the connection is resumed and data is transmitted and received on a user radio bearer (user plane).

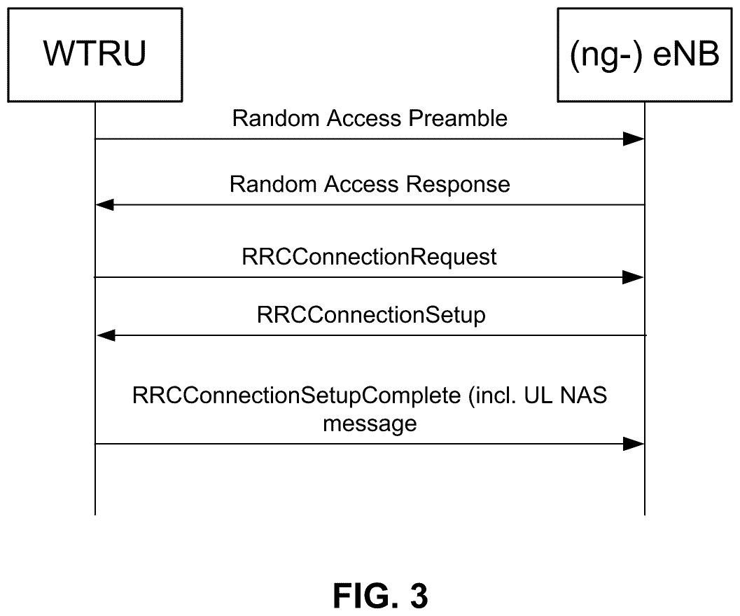

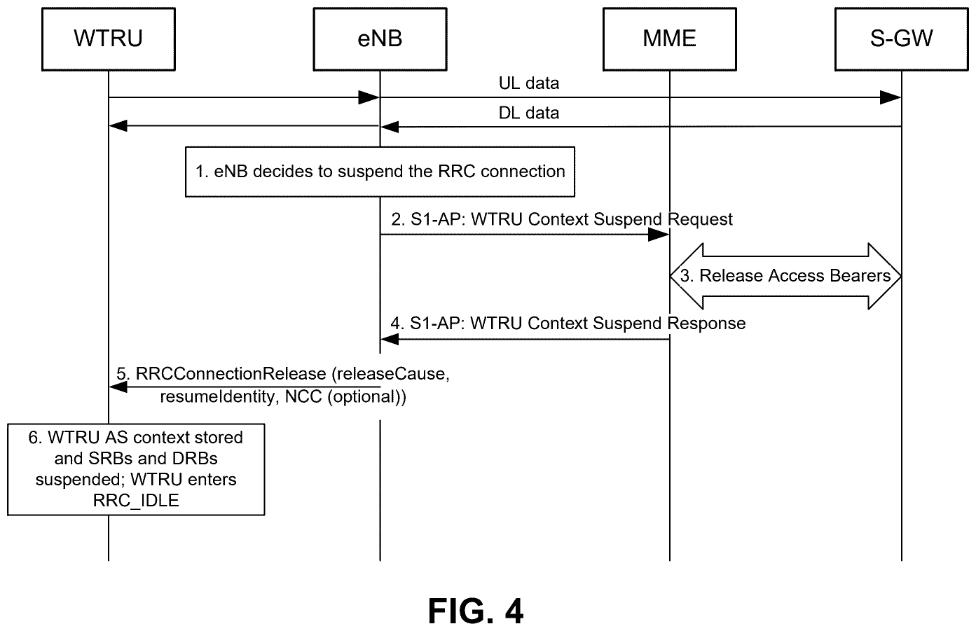

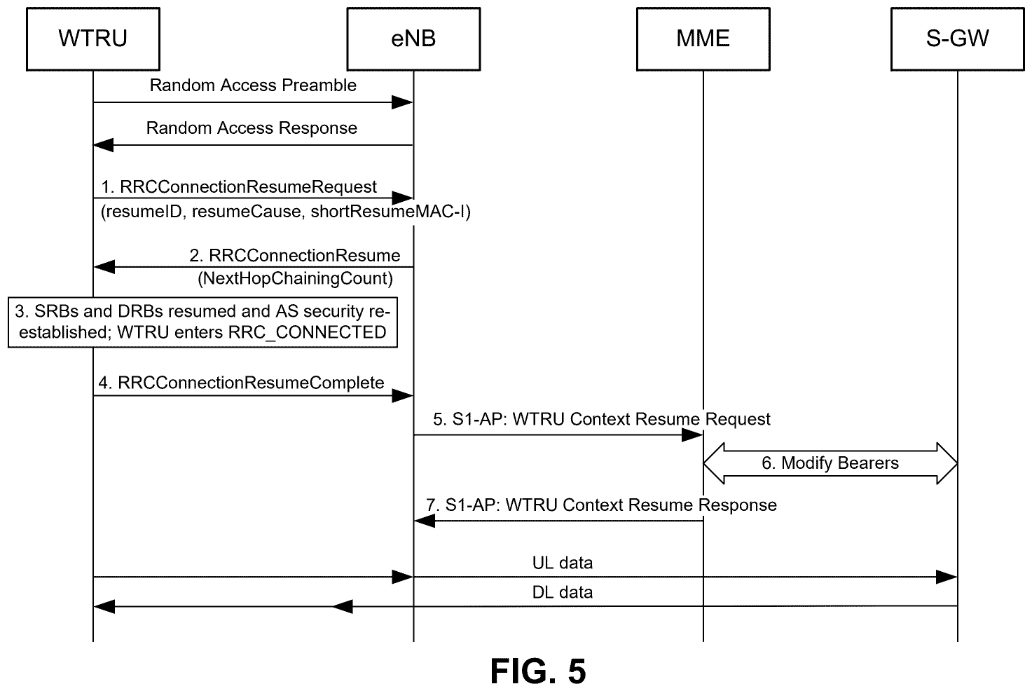

FIG. 3 illustrates an example of a radio resource control (RRC) connection established for control plane CIoT EPS/5GS optimizations. FIG. 4 illustrates an example of an RRC connection suspend procedure in an evolved packet system (EPS). FIG. 5 illustrates an example of an RRC connection resume procedure in EPS.

Examples of early data transmission (EDT), mobile originated early data transmission (MO-EDT), and mobile terminated early data transmission (MT-EDT) are provided herein. MO-EDT may enhance data transmission using the CP and UP modes. MO-EDT may allow an uplink data transmission which may be followed by a downlink data transmission during the random-access procedure. MO-EDT may be triggered when the upper layers have requested the establishment or resumption of the RRC connection for mobile originated data (e.g., not signaling or SMS) and the uplink data size is less than or equal to a TB size indicated in the system information.

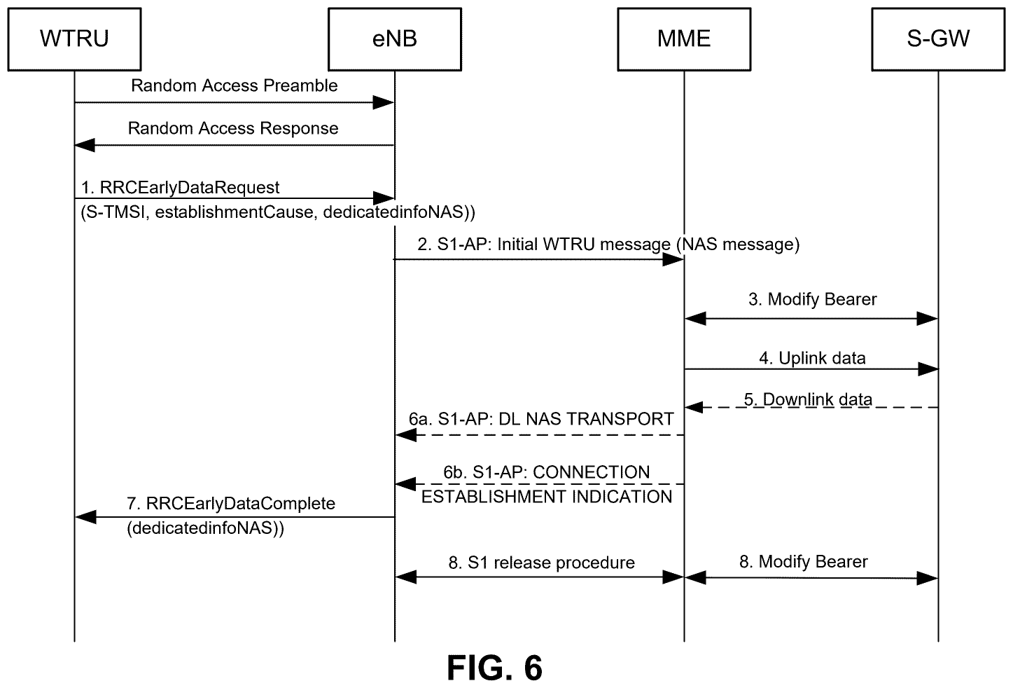

FIG. 6 illustrates an example of a mobile-originated early data transmission (MO-EDT) for control plane cellular internet of things (CIoT) evolved packet system (EPS) optimization. MO-EDT may not be used for data over the control plane if using the user plane CIoT EPS/5GS optimizations.

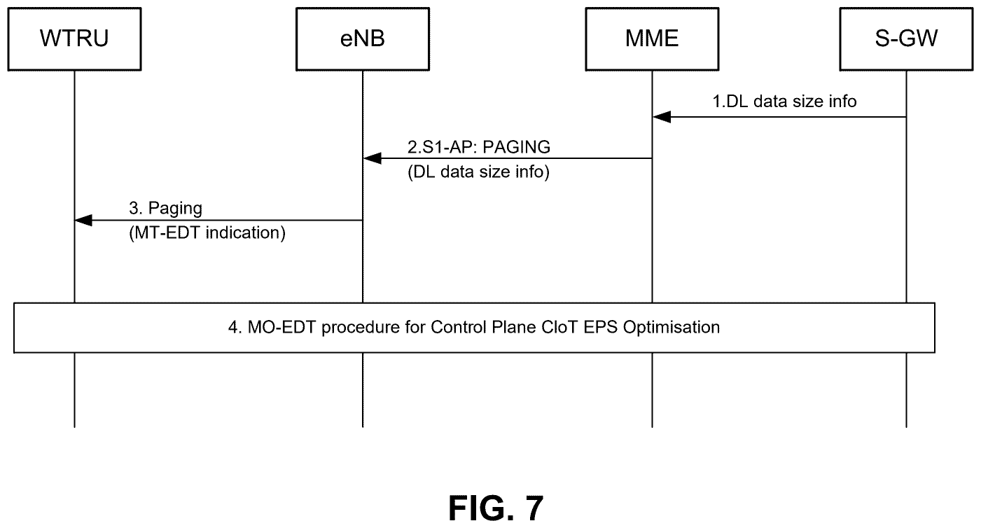

FIG. 7 illustrates an example of an MT-EDT procedure for control plane CIoT EPS optimization. MT-EDT may be intended for a single downlink data transmission during the random-access procedure. MT-EDT may be initiated by the MME if the WTRU and the network support MT-EDT and there is a single DL data transmission for the WTRU.

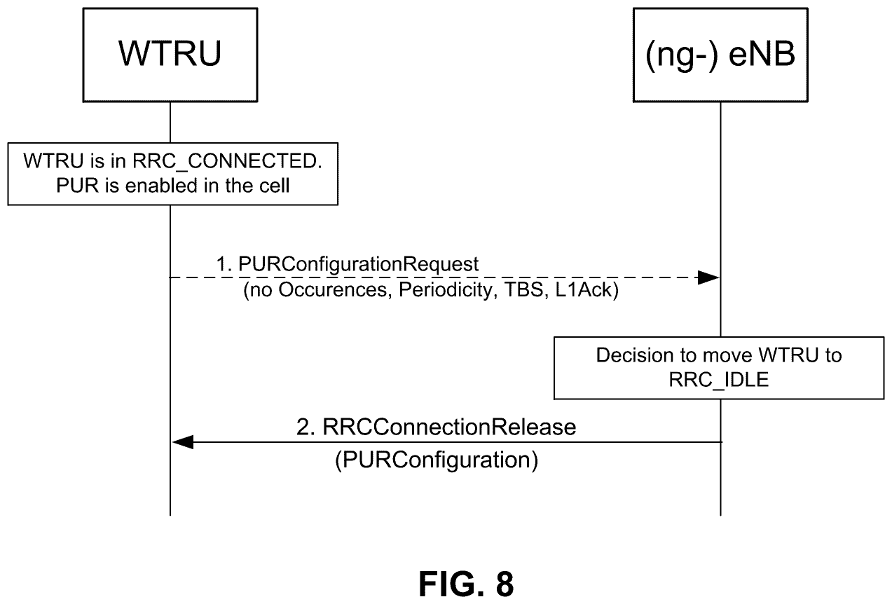

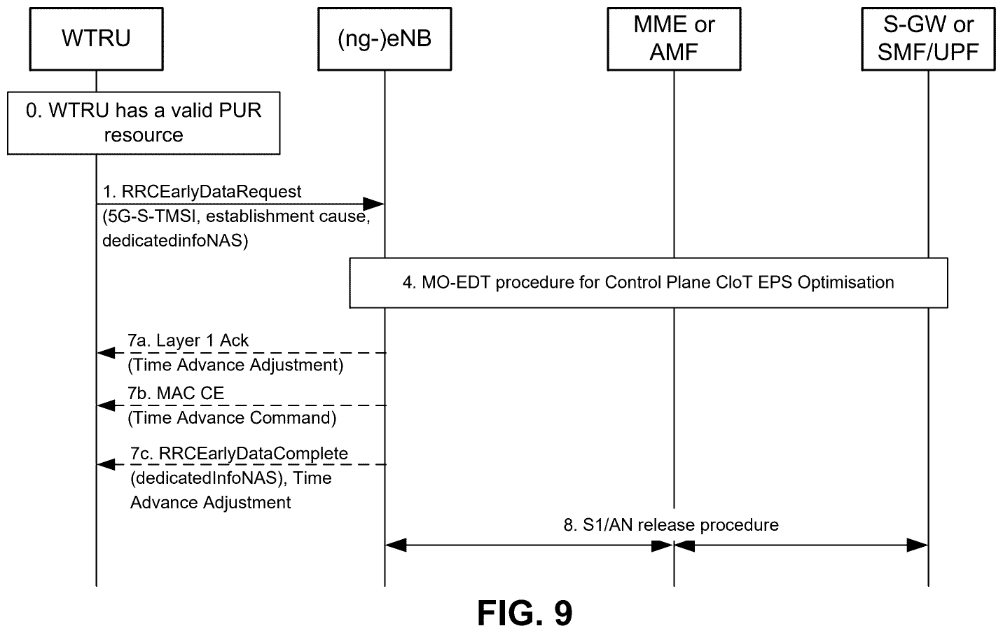

FIG. 8 illustrates an example of a preconfigured uplink resource (PUR) configuration request and a PUR configuration. FIG. 9 illustrates an example of a transmission using PUR for the control plane CIoT EPS/5GS optimizations. Transmissions using PUR may include one uplink transmission from RRC_IDLE using a shared uplink resource without performing the random-access procedure. Transmissions using PUR may be enabled by the (ng-)eNB if the WTRU and the (ng-)eNB support it.

The WTRU may request to be configured with a PUR or to have a PUR configuration released while in RRC_CONNECTED mode. The (ng-)eNB may decide to configure a PUR that may be based on at least one of the WTRU's request, the WTRU's subscription information, or local policy. The PUR may be (e.g., may only be) valid in the cell where the configuration was received. Transmissions using PUR may be triggered when the upper layers request the establishment or resumption of the RRC connection and the WTRU has a valid PUR for transmission and meets the TA validation criteria.

Examples of diversity slotted ALOHA (DSA) and contention resolution diversity slotted ALOHA (CRDSA) are provided herein. Several satellite operators may use one of the transmission schemes known as DSA or CRDSA, which may be provided with various simulations to improve the performance of an uplink transmission in an NTN when using EDT. DSA may transmit multiple copies/duplicates in an order that potentially colliding transmissions can be received by the network with a higher rate of success. By using simple duplicate or replica packets, the DSA scheme may improve conventional SA throughput (e.g., by about a factor of 6 at a packet error rate of 10-2) without any modification in the demodulator.

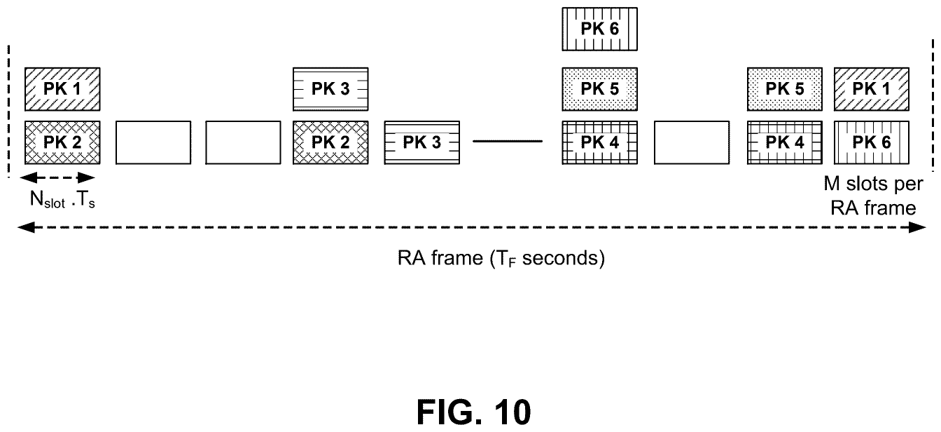

FIG. 10 illustrates an example of packet duplication using CRDSA. As shown in FIG. 10, transmission(s) from different WTRUs may be sent using a total of two duplicate packets (e.g., PK1 from WTRU1, PK2 from WTRU2, etc.). Devices (e.g., each of the devices) may select a different set of uplink resources to perform transmission, such that the probability of collision may be reduced overall. For example, if a first packet collides with the transmission from another WTRU, a second packet may not. A difference between DSA and CRDSA may be the use of advanced interference cancellation with CRDSA. With DSA, the act of simply duplicating packet transmission may reduce the overall probability of collision. With CRDSA, successful decoding of one packet at the receiver may allow for the decoded packet interference to be cancelled with other colliding transmissions. For example (e.g., the above example), packet 3 may be received as it may not collide with other packets. The receiver may (e.g., may then) cancel the interference of packet 3 with the collision between packet 2 and 3, which may result in successful decoding of packet 2 (e.g., even in the presence of a collision). While the performance of DSA may provide improvements in system throughout and reduced collision probability, CRDSA may (e.g., may further) improve system throughout and reduce collision probability.

Examples of NB-IoT random access are provided herein. NB-IoT may use repetitions of transmissions to improve coverage. By repeating the same packet multiple times, the repetitions may be combined at the receiver. Depending on how low the received signal quality is, a larger or smaller number of repetitions may be needed to ensure sufficiently reliable data delivery.

Unless a PUR has been configured, in NB-IoT, the RACH procedure may be contention based and may start with the transmission of a preamble on NPRACH. The WTRU may select a random-access resource, may determine a coverage level based on the downlink measurement, and may select a number of repetitions for a preamble (msg1) transmission based on the determined coverage level.

If the preamble is successfully received (e.g., not colliding), then the network may send a random-access response (RAR/msg2) to the WTRU on NPDCCH, may (e.g., may also) send a number of repetitions of the random-access response to improve coverage, and may (e.g., may also) provide scheduling parameters for msg3 transmission on NPUSCH. The scheduling parameters (e.g., uplink grant) for msg3 may include a number of repetitions for a transmission of msg3. The scheduling parameters may (e.g., may also) include at least one of specific narrowband, MCS, TBS, or a time/frequency location.

Current NB IoT NTN UL system capacity may be severely limited by the corresponding system DL capacity (e.g., due to the larger signaling overhead in the downlink (up to ˜53%)) and the tight coupling between UL and DL signaling. This may (e.g., may also) impact predominantly UL driven traffic (e.g., such as Mobile Originated (MO) transmissions), which may be the primary target of massive IoT and initial emergency messaging use cases supported by IoT NTN. To unlock the additional UL capacity potential, there may be a need to identify examples to decouple the UL from the DL as much as possible. Improving system capacity via reduced DL signaling and techniques (e.g., such as contention-based EDT/PUR and OCC) may be critical to meet the capacity demands and ensure economic viability.

Examples to address uplink capacity are provided herein. Examples of enhancements to reduce the necessary uplink and downlink signaling to complete an early data transmission (EDT) transaction are provided herein. A msg3 transmission may be provided without msg1/random access response (RAR). Efficient delivery (e.g., reduced overhead) of msg4/RRCEarlyDataComplete may be provided. The enhancements may improve the performance of EDT by enabling transmission of msg3 without using Msg1/2 (e.g., PREACH preamble and RAR). A DSA or CRDSA approach may be applied for enabling transmission of an EDT msg3 without performing a preamble transmission (e.g., random-access procedure) and without the need to preconfigure a dedicated resource to the WTRU using PUR. For example, simulations may show the relative gains from DSA and CRDSA schemes over the existing PRACH based transmission.

Examples of DSA being compatible with repetitions are provided herein. If the existing random-access procedure is performed for NB-IoT, the WTRU may first select one of three coverage levels based on comparing the measured downlink RSRP to multiple thresholds. Based on the determination of coverage level, the WTRU may apply one of three configurations for PRACH including a number of repetitions associated with that coverage level for transmitting random access preambles. Msg2 (RAR) may be received by the WTRU, which may be (e.g., may be also) transmitted by the network using repetitions, and the RAR may include an uplink grant for transmission of msg3.

Since msg3 may be (e.g., may be normally) scheduled using RAR with an indication of the number of repetitions, examples may be provided of determining the number of repetitions for msg3 transmission (e.g., using a specific resource allocation, repeated on subsequent transmissions). Examples may be provided of how the number of repetitions for msg3 transmission corresponds to the number of duplicated transmissions (e.g., each may use a different resource allocation, transmitting the same message content using a predefined or determined time-frequency pattern for resource selection).

Msg3 repetitions may be configured per coverage level (e.g., to support transmission of msg3 without a preamble and RAR (msg1/2). Replicas (e.g., each replica) may include the full set of repetitions associated with that coverage level (e.g., to achieve reliability in coverage enhancement). Multiple resource sets may be supported for msg3 transmission with different repetition numbers, but the support of DSA examples may not be considered. The purpose of repetitions may be to improve coverage. The purpose of DSA may be to improve contention failure. Examples of using repetitions and DSA together are provided herein. Using a large number of repetitions to ensure coverage may be demanding on the resource usage. Adding duplication on top may result in an inefficient use of resources.

The WTRU may not know if a transmission (e.g., an initial transmission) fails due to coverage (e.g., not enough repetitions) or contention (e.g., duplicates all collided with other WTRU transmissions). A failure mechanism may be defined to cope with this situation. In cases of poor coverage (e.g., and a high number of repetitions), resource allocation may be expensive (e.g., the maximum repetitions may be 128). The maximum TBS for NPUSCH transmission may be 1000 bits and the maximum delay k0 that can be set may be 64 ms. The maximum number of RUs (NRU) and repetitions (NRep) may be 10 and 128. Depending on the duration of the RUs (e.g., which may be up to 32 ms depending on subcarrier spacing and number), the maximum duration for a NPUSCH transmission may be 10×128×32 ms=40.96 s. Transmitting one duplicate may use 256 TBS in total, which may increase that transmission to 81.92 s.

Examples of determining the correct resources, number of repetitions, and number of duplicate packets if DSA is used for EDT without preamble transmission are provided herein. Examples of handling a failed transmission are provided herein. Examples of minimizing uplink resource usage and transmission time are provided herein.

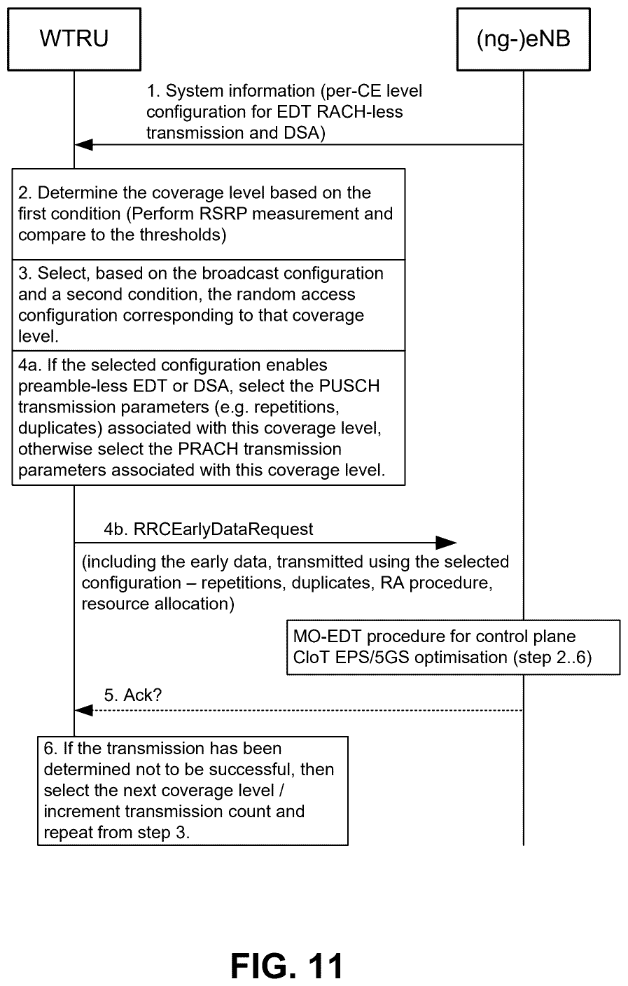

FIG. 11 illustrates an example of an EDT in enhanced coverage using DSA. Examples of how to select the uplink EDT transmission type are provided herein. Examples of random-access procedure type selection are provided herein. Examples of transmission resource allocation are provided herein. Transmission resource allocation may be based on at least one of a repetition number, a number of duplicates, or the associated resource allocation. For the initial transmission (e.g., first transmission) and the subsequent transmission (e.g., second transmission, in case of failure), the network configuration and coverage may be determined.

Examples of determining the coverage level are provided herein. In examples, the WTRU may determine the coverage level (e.g., first coverage level) based on the received signal quality. The WTRU may (e.g., may then) determine whether DSA is enabled based on the determined coverage level. The number of duplicate packets may be determined. The resource allocation (e.g., including repetitions, duplicates, time/frequency resources, etc.) may be determined based on the number of duplicate packets and a condition.

Examples of handling transmission failure are provided herein. Based on a determination of a transmission failure, a next coverage level (e.g., a second coverage level) may be selected and the configuration associated with the next coverage level (e.g., the second coverage level) may be applied. A setting of parameters may be updated, and a condition may be affected. Based on the configuration associated with the next coverage level (e.g., the second coverage level), the WTRU may fall back (e.g., implicitly fall back) to RACH transmission parameters.

A WTRU may receive a broadcast configuration. The broadcast configuration may include at least one of a first condition and a random-access procedure configuration for coverage levels (e.g., for each coverage level). The first condition for determining the coverage level (e.g., the first coverage level) may be performing RSRP measurements and comparing them to measurement thresholds (e.g., the first condition being satisfied may be based on RSRP measurement(s) meeting threshold(s)). Legacy coverage extension (CE) level thresholds may be re-used. There may be three coverage levels in legacy.

Based on preamble-less EDT being enabled for a coverage level (e.g., the first coverage level), the random-access procedure for coverage levels (e.g., for each coverage level) may include a number of PUSCH repetitions for the coverage level (e.g., the first coverage level). Based on preamble-less EDT being enabled for a coverage level (e.g., the first coverage level), the random-access procedure for coverage levels (e.g., for each coverage level) may include a PUSCH resource allocation configuration for the coverage level (e.g., the first coverage level).

The PUSCH resource allocation configuration for the coverage level (e.g., the first coverage level) may include a number of duplicate packets for DSA (e.g., 0 or more) and one or more parameters (e.g., transmission parameters) for determining the resource allocation for the one or more duplicate packets (e.g., for each of the one or more duplicate packets). The one or more parameters (e.g., transmission parameters) may include orthogonal cover code (OCC) parameters; how to assign a repetition number for each duplication (e.g., equal, or could be increased for some duplicates and not others); a narrowband (e.g., frequency location) determination parameter; a resource block (RB) determination parameter; a time between duplicates; or a second condition.

For the OOC parameters, the OCC parameters may include one or more of an OCC length, an OCC sequence index, a DMRS pattern type (e.g., time domain DMRS, code domain DMRS), a DMRS index, a mapping or an assignment of an OCC index with the DMRS index, or an optional linkage of a DMRS pattern with the pattern used for duplicate packets (e.g., a DMRS pattern/sequence (e.g., OCC) may be tied with a duplicate pattern).

For time between duplicates, blind duplication transmissions and non-blind duplication transmission may be applied. Blind duplicate transmissions may be where a WTRU is not supposed to receive some DL indication modifying or updating the subsequent transmission of duplicates. Non-blind duplicate transmissions may be where a WTRU may be indicated to modify/update/cancel the transmission of subsequent duplicate transmissions.

For the second condition, the second condition may be a type of transmission configuration (e.g., whether the random-access configuration is associated with a first transmission or is a retry transmission following a failed transmission). The second condition may be a location or time-based condition. The second condition may be a threshold for enabled DSA for the coverage level. In examples, the first threshold may be used for coverage level selection and to determine the number of repetitions. In examples, a second threshold may be used to determine whether DSA is enabled for the selected coverage level (e.g., in relatively good coverage within the coverage level, DSA may be used, in relatively poor coverage in that coverage level, PRACH may be used). The second condition may be a condition based on an explicit response from the network (e.g., indicate that failure was due to contention (e.g., so add replicas) or coverage (e.g., so increase repetitions)). The second condition may be a condition related to WTRU-ID based parameters (e.g., the WTRU-ID may be used to randomize the selected resources, parameters may be needed to select the distribution). The WTRU-ID may be changed if failure occurs (e.g. incrementally or by using a different hashing function).

The coverage level (e.g., the first coverage level) may be determined based on the first condition being satisfied. The first condition may be performing RSRP measurements and comparing them to thresholds (e.g., same as for if selecting and transmitting a preamble in legacy). The first condition may be satisfied if the RSRP measurements satisfy the thresholds.

A random-access configuration corresponding to the coverage level (e.g., first coverage level) may be selected based on the broadcast configuration and the second condition being satisfied.

Based on the selected configuration (e.g., random-access configuration) enabling a preamble-less EDT (e.g., based on the broadcast configuration and the second condition being satisfied), the resource allocation for the one or more duplicate packets (e.g., for each of the one or more duplicate packets) may be determined. The resource allocation for the one or more duplicate packets (e.g., for each of the one or more duplicate packets) may include one or more of: determining the number of duplicate packets; determining the number of repetitions for each duplicate packet; determining the time between each of the duplicates; determining a narrowband to transmit for each of the duplicates; or determining an RB for each of the duplicates.

Based on the selected configuration (e.g., random-access configuration) not enabling a preamble-less EDT, a random-access preamble may be selected and transmitted according to the parameters associated with the selected coverage level (e.g., a PRACH based transmission may be used associated with PRACH transmission parameters).

The WTRU may transmit, using the preamble-less EDT, the random-access configuration and the PUSCH transmission parameters (e.g., the transmission may use at least one of the preamble-less EDT, the random-access configuration, or the at least one PUSCH resource allocation parameter). The transmission may be via an RRCEarlyDataRequest.

The network may determine whether the transmission has been successful. The determination may be transmitted via an RRC response, L1 ACK, MAC CE, etc. Based on a determination that the transmission is not successful, the WTRU may select the next coverage level (e.g., the second coverage level) or increment a transmission count (e.g., via a counter). Based on the broadcast configuration and the second condition being satisfied, a random-access procedure configuration associated with the second coverage level may be selected.

Based on the next coverage level (e.g., the second coverage level) being selected, a second configuration may be selected. The second configuration may increase the number of repetitions, may increase the number of duplicates, or may disable DSA.

Examples herein may enable support for a preamble-less EDT and/or using DSA for improving collision avoidance and increasing system uplink throughput, while minimizing resource overhead in case of coverage extension repetitions. Failure handling may be configurable, and according to the network deployment, retry procedures may be configurable (e.g., the network may configure DSA for good coverage and PRACH based for poor coverage and failure recovery).

The WTRU may perform one or more of the following examples to perform transmissions of uplink data on a shared uplink resource. The following examples are described in the context of a NB-IoT device operating in an IoT-NTN (satellite based) network. The examples may equally apply to any type of device operating on any network. For example, an LTE device, eMTC device, NR device, etc. The network node may be satellite based, a terrestrial network (e.g., an eNB, gNB), a relay node, airborne, moving, or fixed. Examples herein may describe transmission via shared uplink resources. Examples described herein may apply (e.g., equally apply) to other shared resources such as configured grant(s) and/or semi-persistent scheduling.

Examples of shared uplink resource configurations are provided herein. A WTRU may be configured with one or more uplink resource(s) (e.g., resources in which a WTRU may use to perform an uplink transmission). A WTRU receiving a configuration for one or more uplink resources for a future transmission may be referred to as having a shared uplink resource. Details related to resource configuration, validity, and applicability across cells are described below.

In examples, the WTRU may receive a configuration for transmission on one or more uplink resources (e.g., NPUSCH). This configuration may be received in response to an explicit request for resources (e.g., a PUR-Setup request or a scheduling request), based on network scheduling, or based on information broadcast in system information. In examples, the WTRU may receive a dedicated configuration enabling selection of one or more shared uplink resources. For example, the WTRU may receive an RRC reconfiguration including the configuration for the current cell or one or more other cells. For example, the WTRU may receive a preconfigured uplink resource (PUR) configuration in RRC connection release.

The WTRU may (e.g., may additionally) receive a broadcast configuration in system information. The broadcast configuration may include the configuration of one or more resources which may be used in the current cell (e.g., the cell on which system information is received and a shared uplink resource transmission may occur). The broadcast configuration may be used in conjunction with a dedicated configuration previously received. For example, the WTRU may be configured with dedicated shared uplink resources using dedicated signaling, and contention-based shared uplink resource resources using broadcast signaling.

In examples, some specific parameters may be provided in dedicated signaling, while some default parameters may be provided in broadcast signaling. If the WTRU has not received a dedicated configuration, then the WTRU may use the values provided in broadcast signaling. If the WTRU received a dedicated configuration, then the WTRU may use those values provided by dedicated signaling.

Any combination of parameters and configurations may be allowed by combining broadcast and dedicated signaling. A shared uplink resource occasion may be defined as a set of time/frequency resources or resource blocks in which a WTRU may perform an uplink transmission. A shared uplink resource configuration may include one or more parameters to control the uplink transmission, transmission handling, or describe one or more transmission occasions. A configuration for a shared uplink resource may include one or more of the following: a time or time period to transmit; a frequency or frequency range to transmit one of multiple narrowbands or PRBs; a number of DSA/CRDSA duplicates or replicas; one or more conditions for selection of the resources; one or more resource blocks (RBs); a modulation/coding scheme (MCS) to apply during the transmission; a carrier and/or subcarrier; an NPDCCH configuration; a cyclic shift value for NPUSCH; the number of repetitions for NPUSCH; the number of occasions to perform shared uplink resource transmission; a periodicity for shared uplink resource occasions and a time offset until the first shared uplink resource occasions; a shared uplink resource response window timer; a shared uplink resource time alignment timer value; an OCC configuration (e.g., a specific OCC to use or a set of OCC configurations to select one or more from to use when performing a shared uplink resource transmission); a cell or list of cells in which the shared uplink resource is valid; or a configuration to monitor DL early termination indication from the network. For the OCC configuration, the OOC configuration may provide one or more of the following configuration parameters: OCC length; OCC sequence index; DMRS pattern type (e.g., time domain DMRS, code domain DMRS); DMRS index; mapping or assignment of OCC index with the DMRS index; or optional linkage of DMRS pattern with the pattern used for duplicate packets (e.g., a DMRS pattern/sequence (e.g. OCC) tied with duplicate pattern).

For the configuration to monitor DL early termination indication from the network, the early termination indication may be resource pattern/OCC/DMRS specific, while in another design, the early termination indication may be valid for a group or resource patterns/OCC/DMRS. For the configuration to monitor DL early termination indication from the network, there may be a single early termination indication valid for the whole configuration. For the configuration to monitor DL early termination indication from the network, the early termination indication configuration may be related to PHY layer signaling, or a higher layer signaling (e.g., MAC/RRC signaling). The early termination indication can be paging signaling.

In examples, shared uplink resources may be dedicated (e.g., reserved only for one WTRU or a set of WTRU(s)) or shared (e.g., the WTRUs may be shared among multiple WTRUs). Whether one or more shared uplink resource(s) is shared or dedicated may be explicitly indicated (e.g., within the shared uplink resource configuration), or may be implicitly determined (e.g., via the signaling procedure, where a set of shared uplink resource resources received via dedicated signaling may be assumed as dedicated, and a set of shared uplink resource resources received via broadcast signaling may be considered as shared). A dedicated set of resources may be considered as contention free, and a shared set of resources may be considered as contention based.

The WTRU may be configured to transmit a random-access preamble if using a contention based shared uplink resource (e.g., to transmit a random-access preamble then to transmit using a shared PUSCH). In examples, a set of random access may be reserved for use with a contention based shared uplink resource. The random-access preambles may be associated with certain shared uplink resources. A WTRU may be configured to select a random-access preamble (and shared uplink resource) from a set which may be configured for use if performing a contention-based shared uplink resource transmission. In examples, a WTRU may be configured with both a dedicated and contention based shared uplink resource and may select which to use according to one or more conditions.

A shared uplink resource configuration and/or shared uplink resource transmission occasion may be associated with one or more validity conditions. If the WTRU determines that a shared uplink resource configuration or a shared uplink resource occasion is valid, the WTRU may use the shared uplink resource for uplink transmission. Otherwise, the WTRU may not use the shared uplink resource for uplink transmissions. The WTRU may evaluate the validity of a shared uplink resource and/or shared uplink resource configuration during one or more of the following occasions: prior to a transmission occasion (e.g., the WTRU may evaluate the validity conditions, and may perform a transmission during the occasion if the validity condition(s) are met prior to a transmission occasion); periodically (e.g., the WTRU may periodically evaluate if the validity conditions are satisfied and if satisfied, the WTRU may consider all transmission occasion(s) as valid until the next validity evaluation); if requested by the network; if a shared uplink resource configuration is received and/or modified; or if a cell is reselected.

One or more validity conditions and/or parameters to evaluate the validity conditions (e.g., thresholds, durations etc.) may be provided (e.g., within the shared uplink resource configuration). A validity condition may be one or more of the following: the RSRP exceeding a threshold (e.g., the WTRU may use a shared uplink resource if the RSRP exceeds a threshold); a time or time duration (e.g., the WTRU may consider a shared uplink resource configuration as valid for a specific time period); a number of skipped transmission occasions (e.g., the WTRU may consider the shared uplink resource configuration as invalid if the WTRU skips a configured number of shared uplink resource occasions); the distance of a WTRU exceeding a threshold (e.g., the WTRU has travelled greater than a distance threshold from the time it received the shared uplink resource configuration); the distance of the WTRU and a satellite exceeding a threshold; the distance of the WTRU and a reference point exceeding a threshold; the WTRU location information becoming invalid (e.g., the GNSS location information for a WTRU has expired or has become out of date); the WTRU location information being received longer than X time ago (e.g., the WTRU received the GNSS location information greater than a time period ago); the WTRU changing cells (e.g., the WTRU performs mobility and/or cell reselection to a cell other than the cell which the provided the shared uplink resource configuration); the WTRU changing to a specific cell or set of cells (e.g., the WTRU performs mobility and/or cell reselection to a specific cell and/or set of cells); the WTRU changed satellite orbits (e.g., the WTRU has transitioned from a GSO to NGSO satellite); the WTRU performing an RRC state transition (e.g., the WTRU transitions to RRC connected or RRC IDLE); a number of times a particular type of shared uplink resource has been used (e.g., if contention based shared uplink resource has been used X times); a failure condition associated with a shared uplink resource transmission (e.g., contention failure if using a contention-based shared uplink resource); a timing advance (TA) condition (e.g., the WTRU may use a dedicated shared uplink resource if the WTRU currently has a valid TA for that cell, otherwise, the WTRU may use a contention based shared uplink resource (and may transmit a RA preamble before transmitting using NPUSCH)); whether this is a first transmission attempt, a subsequent attempt, or using a counter (e.g., N attempts); the cell ID belonging to one of the cell IDs (PCIs) indicated where the configuration may be valid for one or more cell IDs; the resource belonging to a cell broadcasting a RNA where the configuration is valid for that RNA; or the resource belonging to a cell broadcasting a TAC (or PLMN) where the configuration is valid for that TAC (or PLMN).

If the WTRU determines that a shared uplink resource is not valid (e.g., one or more validity criteria is not satisfied), the WTRU may perform one or more of the following actions: skip one or more UL transmission occasion(s) (e.g., not transmit on the uplink resources); release the shared uplink resource configuration; send an indication to the network; apply an alternative shared uplink resource configuration (e.g., the WTRU may switch from a dedicated shared uplink resource configuration to a shared configuration); select a new coverage level (e.g., next/lower coverage level); or perform a RACH-based EDT.

A WTRU may receive additional assistance information to evaluate the validity of a shared uplink resource configuration or resource. Examples of assistance information may include one or more of the following: a reference point; satellite ephemeris data (e.g., satellite location, direction, speed, and/or orbital parameters); epoch time of satellite assistance information; satellite footprint information (e.g., radius of cell footprint); or WTRU location information (e.g., GNSS information).

The assistance information may be related to the current serving cell, one or more neighboring cells, and/or one or more neighboring satellites. The assistance information may be received as part of the shared uplink resource configuration or separately (e.g., via RRC signaling, MAC CE, DCI, PDSCH, PDCCH, system information, or NAS signaling).

The WTRU may receive at least one of a shared uplink resource configuration; an indication of shared uplink resources; or assistance information to determine the validity of a shared uplink resource configuration and/or a shared uplink resource occasion via broadcast signaling (e.g., via system information) and/or via dedicated signaling (e.g., via RRC signaling, MAC CE, DCI, PDSCH, PDCCH, or NAS signaling).

The WTRU may receive one or more aspects of a shared uplink resource configuration via different signaling examples. For example, the WTRU may receive a first set of parameters of a shared uplink resource configuration via dedicated signaling and a second set of parameters via broadcast signaling. If a parameter is provided by both dedicated and broadcast signaling, the WTRU may select which value to apply based on one or more of the following rules: the WTRU may always apply the value received via dedicated signaling; the WTRU may always apply the most recent value; the WTRU may select a value based on WTRU implementation; the WTRU may select a value based on the data to be transmitted; or the WTRU may select a value based on any of the criteria which may be used for shared uplink resource selection.

The coverage level may be determined using a criteria corresponding to the downlink signal quality (e.g., a RSRP threshold). For example, the WTRU may be configured with coverage levels CE level 0, CE level 1, CE level 2. The WTRU may determine the WTRU is using CE level 0 if the measured DL RSRP is above a first threshold. If the DL RSRP is not above a first threshold, then the WTRU may determine the WTRU is using CE level 1 if the DL RSRP is above a second threshold. If the DL RSRP is not above the first or the second threshold, then the WTRU may determine the WTRU is using CE level 2.

The WTRU may receive a configuration corresponding to one or more coverage levels. The configuration may include, for each of the configured coverage levels, any of the information listed above. For example, the WTRU may receive an indication of the number of PUSCH repetitions to use for that coverage level. The WTRU may receive an indication that RACH-less transmission is enabled (e.g., so the WTRU may transmit using the PUSCH resources without transmitting RACH) or disabled (e.g., so WTRU may transmit random access preambles and may not transmit using PUSCH until an RAR with a scheduling grant is received). The WTRU may receive an indication of whether DSA or CRDSA is enabled for this coverage level. The WTRU may receive an indication of the number of replicas to transmit for this coverage level. The WTRU may receive OCC parameters based upon which the WTRU may determine the suitable OCC and DMRS for each repetition and duplicate transmission. The OCC configuration may provide one or more of the following configuration parameters: an OCC length; an OCC sequence index; a DMRS pattern type (e.g., time domain DMRS, code domain DMRS); a DMRS index; a mapping or assignment of an OCC index with the DMRS index; or an optional linkage of DMRS pattern with the pattern used for duplicate packets (e.g., DMRS pattern/sequence (e.g. OCC) tied with duplicate pattern). The WTRU may receive an indication of how to assign a repetition number for each duplicate (e.g., a different number of repetitions may be received for each duplicate). The WTRU may receive an indication of a narrowband (e.g., frequency location) determination parameter. The WTRU may receive an indication of a resource block or resource allocation determination parameter. There may be time between duplicates. For example, the WTRU may select a random number or number based on a WTRU-ID to determine which narrowband, RB, timing, to use for each replica. The WTRU may receive parameters (e.g., additional parameters) for determining any of the above based on a second condition.

The second condition may be used to determine one or more of the configuration parameters. The second condition may be one or more of: a type of transmission condition; a location or time-based condition; a threshold for enabling the DSA for the coverage level; a condition based on an explicit response from the network; or a condition based on WTRU-ID parameters.

For the type of transmission condition, the WTRU may determine whether the transmission is the first transmission attempt or whether the transmission is a failure or retry (e.g., a failure may be determined if the WTRU transmits the maximum number of repetitions or replicas of a particular msg3).

For the location or time-based condition, certain resources may be applicable when the WTRU is within a threshold distance from a reference location, or within a certain time window.

For the threshold for enabling the DSA for the coverage level, the WTRU may use a first threshold for coverage level selection and/or to determine the repetitions. The WTRU may use a second threshold to determine whether DSA is enabled for that coverage level. For example, in relatively good coverage within the coverage level, the DSA may be enabled. In relatively poor coverage in that coverage level, PRACH may be used. In examples, the WTRU may use repetitions and DSA on a first transmission attempt of a particular msg3. If determining that a failure occurs, the WTRU may determine whether to increase the number of replicas (e.g., above a second threshold) or increase the number of repetitions (e.g., below a second threshold).

For the condition based on an explicit response from the network, the network may indicate that failure was due to contention (e.g., so add replicas) or coverage (e.g., so increase repetitions).

For the condition based on WTRU-ID parameters, WTRU-ID may be used to randomize the selected resources. Parameters may be needed to select the distribution. The WTRU may apply a hash function to the WTRU-ID to determine a number or index to use for selecting a particular set of resources or resource allocations, resource pattern, timing, or frequency (e.g., similar to a paging occasion determination). The WTRU may change or update (e.g., increment) the ID or function to use on the ID if failure occurs.

Examples of shared uplink resource selection are provided herein. The WTRU may perform selection (e.g., initial selection) of a set of uplink resources based on the determined coverage level (e.g., the first condition). The coverage level (e.g., as explained herein) may be determined by comparing the measured downlink signal quality to one or more thresholds. The WTRU may select a first set of resources based on the selected coverage level. The WTRU may perform a selection (e.g., further selection) of a subset of one or more resources from the selected set of uplink resources. For example, the WTRU may determine one or more resources to use based on the configuration parameters associated with the selected coverage level, a random number, a WTRU-ID, or a second condition (e.g., as described herein). Based on the selection of a set of resources (e.g., using a selected coverage level) and selection of a subset of resources from within the set (e.g., based on a rule, ID, second condition), the WTRU may transmit (e.g., transmits msg3 and early data) using the determined resources and parameters (e.g., number of replicas, number of repetitions, and resource allocation(s)).

A WTRU may be configured to transmit duplicate transmissions. The WTRU may be configured to transmit duplicate transmissions as part of DSA or CRDSA scheme. The WTRU may be configured to select a suitable pattern for duplicate transmissions based on WTRU identity. The WTRU identity may be a suitable identity (e.g., IMSI or WTRU-ID). For example, the WTRU may use the modulo or remainder operation to determine a pattern for transmission (e.g., WTRU divides the WTRU identity by the number of patterns received as part of the configuration and determines the integer remainder). The WTRU may (e.g., may then) pick the pattern which corresponds to the remainder. If WTRU ID is denoted by u and there are n patterns configured, the selected pattern may be selected pattern=u−n*floor (u/n).

A WTRU may first determine OCC parameters and may (e.g., may then) use the determined OCC parameters to determine the resource pattern for duplicate transmission. A WTRU may be configured to transmit an OCC based uplink transmission on a shared resource. The WTRU may determine OCC parameters based on one or more of the following: the received configuration; WTRU identity (e.g., IMSI, WTRU-ID, or some other suitable identity); a determined coverage level; a determined sub-coverage level within a determined coverage level; a determined resource for UL transmission; a determined pattern for duplicate/replica transmission; the number of duplicates; the number of repetitions for each duplicate; or the total number of duplicates x repetitions.

A WTRU may first determine OCC parameters and may (e.g., may then) use the determined OCC parameters to determine the resource pattern for duplicate transmission. In examples, the WTRU may first determine the resource pattern. The WTRU may (e.g., may then) determine the OCC parameters to use for UL transmission based on the resource pattern. The WTRU may determine the OCC parameters based on at least one of: the received configuration(s); DL measurements; or the type of cells/orbit. The WTRU may determine one or more of the following parameters for its UL transmission: OOC length; OOC sequence index; DMRS pattern type; or DMRS index.

For OCC length, the WTRU may choose a suitable OCC length for UL transmission. If one or more OCC lengths are configured, the WTRU may choose a length based on one more of the following: the number of repetitions, number of duplicates, the determined pattern, the determined coverage level, the number of symbols/slots in each resource, the number symbols/slots in each repetition, etc.

For OCC sequence index, the WTRU may determine an OCC index based on at least one of the configuration(s), OCC length, DL measurements, determined coverage level, or WTRU identity. In examples, the WTRU may determine the resource pattern index and OCC index jointly. In examples, the WTRU may determine the OCC index and resource pattern index independently. In examples, the WTRU may consider the total number of available resources as number of patterns*OCC length, and may (e.g., may then) determine a suitable pattern and OCC index based on WTRU identity (e.g., using a modulo operation based on WTRU identity).

For DMRS pattern type (e.g., time domain DMRS, code domain DMRS), the WTRU may be configured to select time domain or code domain DMRS. In examples, the WTRU may be provided only a single DMRS pattern as part of the configuration. In examples, different resource patterns may be associated with different DMRS pattern types.

For DMRS index, the WTRU may determine the DMRS index based on the configuration. In examples, the resource patterns may be provided with one DMRS index only, explicitly or implicitly. In examples, the resource patterns may be provided with multiple DMRS indices. In examples, the DMRS indices may be related to the OCC indices. If the DMRS is related to the OOC indices, the WTRU may determine an OCC index for transmission and may select the DMRS index corresponding to the selected/determined OCC index.

The WTRU may update the selection of shared uplink resources (e.g., after initial selection of the transmission parameters for shared uplink resources). The WTRU may perform this update based on either determining the initial transmission was unsuccessful (e.g., failed) or based on an explicit indication from the network.

In examples, updating the selection of shared uplink resources may include selecting the next coverage level and then selecting the parameters associated with the next coverage level. For example, if the WTRU has initially selected CE level 0, but determines that the procedure has failed after performing the maximum number of repetitions and replica transmissions, the WTRU may (e.g., may then) select CE level 1 and perform transmission according to the CE level 1 configuration. For CE levels corresponding to poorer coverage, the DSA and RACH-less/preamble-less operation may be disabled. This may mean that a WTRU selecting that coverage may by default use preamble based random access. This may be due to an initial selection of a lower coverage level or failure after selecting a higher coverage level.

In examples, the WTRU may increment a counter (e.g., N transmission attempts) and use the second condition to determine parameters to use for transmission. For example, if the condition is based on a second threshold, the WTRU may increment the number of replicas if the RSRP is determined to be above the second threshold or may increment the number of repetitions if the RSRP is determined to be below the second threshold.

The WTRU may determine if a transmission failure has occurred if no response has been received within a certain timeframe after performing the maximum number of repetitions or replica transmissions. The WTRU may determine if a transmission failure has occurred if it receives a negative acknowledgement identifying the particular transmission. For example, a negative acknowledgement addressed to that particular WTRU, or an acknowledgement identifying the resource the WTRU used for transmission but addressing a different WTRU. The acknowledgement may be a contention resolution MAC CE either including the WTRU identity used for transmission (positive), or another WTRU identity (negative).

A WTRU may be configured to transmit an indication to the network. The WTRU may be configured to transmit an indication to the network as part of its UL transmission over the shared resource. The WTRU may provide an indication of one or more of the following: a WTRU determined resource; a WTRU determined resource pattern; a WTRU determined CE level; a WTRU determined sub-CE level; a WTRU determined number of repetitions/replicas/duplicates; an indication related to the resource for different repetitions/replicas/duplicates that the WTRU has determined and intends to transmit; WTRU determined OCC parameters (e.g., OCC length, OCC index, DMRS pattern type, DMRS index, etc.); or whether the WTRU supports receiving an early termination indication or not.

Examples of downlink feedback are provided herein. In examples, the network may detect whether a problem has occurred due to contention (e.g., all of a particular WTRU replicas collided) or due to coverage (e.g., not enough repetitions to decode). In examples, the WTRU may receive an explicit indication as part of or instead of an acknowledgement or contention resolution MAC CE, which may inform the WTRU whether to update (e.g., increase) the number of repetitions, to update (e.g., increase) the number of replicas, to update (e.g., change) the resource pattern used, or to select a configuration corresponding to a particular index or coverage level.

A WTRU may be configured to receive an indication from the network (e.g., a L1 ACK on PDCCH, a MAC CE, or an RRC message). The WTRU may be configured to receive an indication for an early termination of a UL transmission over the shared resource. The WTRU may be configured to detect and monitor early termination as part of the configuration for shared UL resource. The WTRU may be configured to receive an early termination indication when the WTRU is transmitting in the UL direction in a contention-based resource. The WTRU may receive the early termination indication from the network as PHY signaling or higher layer signaling. The early termination indication may be transmitted by the network in a broadcast manner or groupcast manner. The early termination indication may provide an indication of a specific resource, or it may be transmitted by the network in relation to contention-based EDT resources (e.g., all contention-based EDT resources).

If receiving an early termination indication, the WTRU may determine if the indication is relevant for its UL transmission. The WTRU may determine the indication to be relevant for its UL transmission if the WTRU is transmitting in the UL direction and the WTRU receives an early termination indication, where the indication is related to the WTRU resource pattern or the indication is related to the resources (e.g., all the resources).

The WTRU may receive an early termination indication from the network for one or more of the following: an ACK from the network; resource pattern overloading; or OCC and/or DMRS code overloading.

For the ACK from the network, the WTRU may receive an early termination indication from the network based on a network successfully decoding WTRU data. For example, the WTRU may have selected a pattern with several duplicate transmissions and the network may be able to decode the data. The network may (e.g., may then) transmit an ACK to save the WTRU from subsequent transmissions over the determined/indicated resource pattern.

For resource pattern overloading, the WTRU may receive an early termination indication from the network where the network detects multiple WTRUs transmitting over the same resource/pattern, and the network provides early indication, so that the WTRU may select a different resource. With this type of indication, the network may indicate a back-off time, an alternative pattern, an alternative OCC, etc. to use.

For OCC and/or DMRS code overloading, several WTRUs may select the same OCC index (and/or DMRS index) in relation to their UL transmissions over the shared resource. As overloading the OCC code (and/or DMRS code) may lead to very high interference levels, the network may provide an early termination indication, which may instruct the WTRUs using a specific resource/pattern to abort their transmissions.

A WTRU may receive an indication of an early termination from the network. The WTRU may determine if the early termination indication is an ACK for successful reception or pertains to any of the failure cases (e.g., resource pattern overloading, OCC overloading, DMRS overloading, etc.). If the WTRU determines that the early indication is an ACK for the successful reception of WTRU data, the WTRU may determine the reception of early termination indication as completion of an EDT transaction and/or RRC connection release message.

If the WTRU determines that the early indication is related to any of the failure cases (e.g., resource pattern overloading, OCC overloading, DMRS overloading etc.), based on the WTRU determining the failure of its UL transmission and the information (e.g., additional information) received as part of the early termination indication, the WTRU may perform one or more of the following: re-select the EDT resource and re-transmit; back off for a configured/indicated time and re-transmit; fall back to a different CE level; fall back to a RACH preamble based transmission over the same/different CE level; re-transmit over a CE level or resource pattern and/or OCC/DMRS where the WTRU receives an indication of CE level/pattern/OCC/DMRS as part of the early termination indication; increase or decrease the number of repetitions; increase or decrease the number of replicas; or increase or decrease the transmission power.

Examples of how to select the uplink EDT transmission type are provided herein. Examples of random-access procedure type selection are provided herein. Examples of transmission (e.g., first transmission) resource allocation are provided herein. Transmission resource allocation may be based on at least one of a repetition number, a number of duplicates, or the associated resource allocation. For the initial transmission (e.g., first transmission) and the subsequent transmission (e.g., second transmission, in case of failure), the network configuration and coverage may be determined.

Examples of determining the coverage level are provided herein. The coverage level may be determined based on whether DSA is enabled for that coverage level. The number of duplicate packets may be determined. The resource allocation (e.g., including repetitions, duplicates, time/frequency resources, etc.) may be determined based on the number of duplicate packets and a condition.

Examples of handling transmission failure are provided herein. Based on a determination of a transmission failure, a next coverage level (e.g., a second coverage level) may be selected and the configuration associated with the next coverage level (e.g., the second coverage level) may be applied. A setting of parameters may be updated and a condition may be affected. Based on the configuration associated with the next coverage level (e.g., the second coverage level), the WTRU may fall back (e.g., implicitly fall back) to RACH transmission parameters.

A WTRU may receive a broadcast configuration. The broadcast configuration may include at least one of a first condition and a random-access procedure configuration for coverage levels (e.g., for each coverage level). The first condition for determining the coverage level (e.g., the first coverage level) may be performing RSRP measurements and comparing them to measurement thresholds (e.g., the first condition being satisfied may be based on RSRP measurement(s) meeting threshold(s)). Legacy CE level thresholds may be re-used. There may be three coverage levels in legacy.

Based on preamble-less EDT being enabled for a coverage level (e.g., the first coverage level), the random-access procedure for coverage levels (e.g., for each coverage level) may include a number of PUSCH repetitions for the coverage level (e.g., the first coverage level). Based on preamble-less EDT being enabled for a coverage level (e.g., the first coverage level), the random-access procedure for coverage levels (e.g., for each coverage level) may include a PUSCH resource allocation configuration for the coverage level (e.g., the first coverage level).

The PUSCH resource allocation configuration for the coverage level (e.g., the first coverage level) may include a number of duplicate packets for DSA (e.g., 0 or more) and one or more parameters (e.g., transmission parameters) for determining the resource allocation for the one or more duplicate packets (e.g., for each of the one or more duplicate packets). The one or more parameters (e.g., transmission parameters) may include OCC parameters; how to assign a repetition number for each duplication (e.g., equal, or could be increased for some duplicates and not others); a narrowband (e.g., frequency location) determination parameter; a resource block (RB) determination parameter, a time between duplicates, or a second condition.

For the OOC parameters, the OCC parameters may include one or more of an OCC length, an OCC sequence index, a DMRS pattern type (e.g., time domain DMRS, code domain DMRS), a DMRS index, a mapping or an assignment of an OCC index with the DMRS index, or an optional linkage of a DMRS pattern with the pattern used for duplicate packets (e.g., a DMRS pattern/sequence (e.g., OCC) may be tied with a duplicate pattern).

For time between duplicates, blind duplication transmissions and non-blind duplication transmission may be applied. Blind duplicate transmissions may be where a WTRU is not supposed to receive some DL indication modifying or updating the subsequent transmission of duplicates. Non-blind duplicate transmissions may be where a WTRU may be indicated to modify/update/cancel the transmission of subsequent duplicate transmissions.

For the second condition, the second condition may be a type of transmission configuration (e.g., whether the random-access configuration is associated with a first transmission or is a retry transmission following a failed transmission). The second condition may be a location or time-based condition. The second condition may be a threshold for enabled DSA for the coverage level. In examples, a second threshold may be used to determine whether DSA is enabled for that coverage level (e.g., in relatively good coverage within the coverage level, DSA may be used, in relatively poor coverage in that coverage level, PRACH may be used). In examples, the first threshold may be used for coverage level selection and to determine the number of repetitions. The second condition may be a condition based on an explicit response from the network (e.g., indicate that failure was due to contention (e.g., so add replicas) or coverage (e.g., so increase repetitions)). The second condition may be a condition related to WTRU-ID based parameters (e.g., the WTRU-ID may be used to randomize the selected resources, parameters may be needed to select the distribution). The ID may be changed if failure occurs (e.g. incrementally or by using a different hashing function).

The coverage level (e.g., the first coverage level) may be determined based on the first condition being satisfied. The first condition may be performing RSRP measurements and comparing them to thresholds (e.g., same as for if selecting and transmitting a preamble in legacy). The first condition may be satisfied if the RSRP measurements satisfy the thresholds.

A random-access configuration corresponding to the coverage level (e.g., first coverage level) may be selected based on the broadcast configuration and the second condition being satisfied.

Based on the selected configuration (e.g., random-access configuration) enabling a preamble-less EDT (e.g., based on the broadcast configuration and the second condition being satisfied), the resource allocation for the one or more duplicate packets (e.g., for each of the one or more duplicate packets) may be determined. The resource allocation for the one or more duplicate packets (e.g., for each of the one or more duplicate packets) may include one or more of: determining the number of duplicate packets; determining the number of repetitions for each duplicate packet; determining the time between each of the duplicates; determining a narrowband to transmit for each of the duplicates; or determining an RB for each of the duplicates.

Based on the selected configuration (e.g., random-access configuration) not enabling a preamble-less EDT, a random-access preamble may be selected and transmitted according to the parameters associated with the selected coverage level (e.g., a PRACH based transmission may be used associated with PRACH transmission parameters).

The WTRU may transmit, using the preamble-less EDT, the random-access configuration and the PUSCH transmission parameters (e.g., the transmission may use at least one of the preamble-less EDT, the random-access configuration, or the at least one PUSCH resource allocation parameter). The transmission may be via an RRCEarlyDataRequest.

The network may determine whether the transmission has been successful. The determination may be transmitted via an RRC response, L1 ACK, MAC CE, etc. Based on a determination that the transmission is not successful, the WTRU may select the next coverage level (e.g., the second coverage level) or increment a transmission count. Based on the broadcast configuration and the second condition being satisfied, a random-access procedure configuration associated with the second coverage level may be selected.

Based on the next coverage level (e.g., the second coverage level) being selected, a second configuration may be selected. The second configuration may increase the number of repetitions, may increase the number of duplicates, or may disable DSA.

Examples herein may enable support for a preamble-less EDT, using DSA for improving collision avoidance and increasing system uplink throughput, while minimizing resource overhead in case of coverage extension repetitions. Failure handling may be configurable, and according to the network deployment, retry procedures may be configurable (e.g., the network may configure DSA for good coverage and PRACH based for poor coverage and failure recovery).

For example, CE level 0 may be configured with 4 repetitions and 4 duplicate packets. CE level 1 may be configured with 8 repetitions and 2 duplicate packets. CE level 2 may be configured to use PRACH (RACH-less is disabled) with 16 repetitions. In this example, if the WTRU selects CE level 0 or 1, the WTRU may transmit the same amount of data in the uplink (e.g., either 4*4 or 8*2).

WTRU contention failure may be improved by DSA and RACH congestion may be avoided, but allowing different configurations depending on the coverage level may limit the resource at the expense of slightly more contention. These parameters may be tweaked by the network depending on the deployment scenario. This may enable both contention probability and coverage to be considered if using preamble-less EDT.

CE level 2 may not configure DSA or RACH-less. WTRU may use PRACH (e.g., in this case) to ensure the large resource usage occurs (e.g., only occurs) if the network provides an explicit grant in RAR explicitly indicating the number of PUSCH repetitions. The WTRU may use a dedicated resource to avoid contention on PUSCH.

If the WTRU selects CE level 0 or 1, the WTRU may determine a resource allocation for the duplicate packets (e.g., each of the duplicate packets) using a rule based on at least one of a number of repetitions, a number of duplicates, initial resource allocation, or a random number (or function of WTRU ID). If the WTRU selecting CE level 0 determines that the transmission failed (e.g., receives a NACK or no response), the WTRU may (e.g., may then) select CE level 1 and may repeat the process using the configuration for CE level 1. If the WTRU selecting CE level 1 (e.g., either initially or after failing with CE level 0) determines that the transmission failed, the WTRU may (e.g., may then) select CE level 2 and may perform random-access using PRACH, with the parameters configured for CE level 2.

These examples may enable more efficient operation if the coverage level is relatively good, by employing fewer repetitions, but more duplicates, to ensure successful transmission. The lowest CE level may provide reliability by using preamble-based RACH with a high number of repetitions. This may allow for full flexibility for the network to configure appropriate parameters based on at least one of network load, coverage, reliability, or deployment scenario.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit receive unit (WTRU), comprising:
a processor configured to:
receive broadcast configuration information, wherein the broadcast configuration information indicates a first condition and a second condition;
based on the first condition being satisfied, determine a first coverage level;
based on the broadcast configuration information and based on the second condition being satisfied, select a random-access configuration associated with the first coverage level;
determine that the random-access configuration enables a preamble-less early data transmission (EDT); and
send a transmission that uses at least the preamble-less EDT.

2. The WTRU of claim 1, wherein the processor is further configured to:
based on the determination that the random-access configuration enables the preamble-less EDT, determine at least one physical uplink shared channel (PUSCH) resource allocation parameter.

3. The WTRU of claim 2, wherein the transmission further uses the at least one PUSCH resource allocation parameter.

4. The WTRU of claim 2, wherein the at least one PUSCH resource allocation parameter includes a number of duplicate packets or a number of repetitions for each duplicate packet.

5. The WTRU of claim 2, wherein the at least one PUSCH resource allocation parameter includes any of: a number of duplicate packets, a number of repetitions for each duplicate packet, a time between each duplicate packet, a narrowband to transmit for each duplicate packet, or a resource block (RB) for each duplicate packet.

6. The WTRU of claim 1, wherein the processor is further configured to:
based on a determination that the transmission is not successful, select a second coverage level.

7. The WTRU of claim 1, wherein the second condition is a threshold for enabling diversity slotted ALOHA (DSA) for the first coverage level.

8. The WTRU of claim 1, wherein the second condition is at least one of: a type of transmission condition, a location or time-based condition, a threshold for enabling DSA for the first coverage level, a condition based on an explicit response from a network, or a condition based on WTRU-ID based parameters.

9. The WTRU of claim 1, wherein the transmission further uses the random-access configuration.

10. The WTRU of claim 1, wherein the first condition being satisfied is a reference signal reference power (RSRP) measurement meeting a threshold.

11. A method associated with a wireless transmit receive unit (WTRU), the method comprising:
receiving broadcast configuration information, wherein the broadcast configuration information indicates a first condition and a second condition;
based on the first condition being satisfied, determining a first coverage level;
based on the broadcast configuration information and based on the second condition being satisfied, selecting a random-access configuration associated with the first coverage level;
determining that the random-access configuration enables a preamble-less early data transmission (EDT); and
sending a transmission that uses at least the preamble-less EDT.

12. The method of claim 11, further comprising:
based on the determination that the random-access configuration enables the preamble-less EDT, determining at least one physical uplink shared channel (PUSCH) resource allocation parameter.

13. The method of claim 12, wherein the transmission further uses the at least one PUSCH resource allocation parameter.

14. The method of claim 12, wherein the at least one PUSCH resource allocation parameter includes a number of duplicate packets or a number of repetitions for each duplicate packet.

15. The method of claim 12, wherein the at least one PUSCH resource allocation parameter includes any of: a number of duplicate packets, a number of repetitions for each duplicate packet, a time between each duplicate packet, a narrowband to transmit for each duplicate packet, or a resource block (RB) for each duplicate packet.

16. The method of claim 11, further comprising:
based on a determination that the transmission is not successful, selecting a second coverage level.

17. The method of claim 11, wherein the second condition is a threshold for enabling diversity slotted ALOHA (DSA) for the first coverage level.

18. The method of claim 11, wherein the second condition is at least one of: a type of transmission condition, a location or time-based condition, a threshold for enabling DSA for the first coverage level, a condition based on an explicit response from a network, or a condition based on WTRU-ID based parameters.

19. The method of claim 11, wherein the transmission further uses the random-access configuration.

20. The method of claim 11, wherein the first condition being satisfied is a reference signal reference power (RSRP) measurement meeting a threshold.
